(19) United States
(12) Patent Application Publication
(10) Pub. No.: US 2017/0247919 A1
(43) Pub. Date: Aug. 31, 2017

(54) TELESCOPING DOOR SECURITY BAR

(71) Applicant: Charles Edward Roseberry, JR., Ooltewah, TN (US)

(72) Inventor: Charles Edward Roseberry, JR., Ooltewah, TN (US)

(21) Appl. No.: 15/056,388

(22) Filed: Feb. 29, 2016

(51) Int. Cl. E05C 19/00; E05C 17/48; E05C 17/52; E05C 17/44

(52) U.S. Cl. CPC E05C 19/004; E05C 17/44; E05C 17/48; E05C 17/52

(57) ABSTRACT

A telescoping door security bar for preventing intruders from entering a room. The telescoping door security bar uses a bolt and cotter pin, which are inserted completely through the door security bar to make it more stable.

### BACKGROUND OF THE INVENTION

The present invention relates to security systems, and more particularly, to security systems for preventing entry through a doorway.

Locks and deadbolts and combinations thereof are common security measures to control the opening of a door way entrance to a room or a dwelling. However, when these items fail or are rendered useless by an intruder, there is nothing left to prevent the opening of the door and stopping an intruder's entry into the area.

As can be seen, there is a need for a security device that prevents the opening of a door when locks and deadbolts fail or rendered useless.

### SUMMARY OF THE INVENTION

In one aspect of the present invention, a telescopic security apparatus is provided which has a first tubular member having a yoke attached to a top end thereof; a second tubular member having a foot operatively attached to a bottom end thereof, wherein the first tubular member is telescopically coupled with the first tubular member; a plurality of apertures defined in a first spaced apart relation through an opposed sidewall of the first tubular member; a plurality of cooperating apertures defined in a second spaced apart relation through an opposed sidewall the second tubular member in; and a bolt received through a selected aperture and a selected cooperating aperture. The telescopic security apparatus foot is provided with a frictional surface defined on a lower surface thereof adapted for non-slipping frictional engagement with a floor surface. The bolt may further include a hole extending through a transverse axis thereof. The telescopic security apparatus may also include a retaining pin received in the hole. In a preferred embodiment, the yoke is adapted to substantially surround a shaft of a doorknob.

Other aspects of the invention included a method of securing a doorway, the method including: 1) providing a telescopic door security bar having a first tubular member having a yoke attached to a top end thereof; a second tubular member having a foot operatively attached to a bottom end thereof, wherein the first tubular member is telescopically coupled with the first tubular member; a plurality of apertures defined in a first spaced apart relation through an opposed sidewall of the first tubular member; a plurality of cooperating apertures defined in a second spaced apart relation through an opposed sidewall the second tubular member in; and a bolt received through a selected aperture and a selected cooperating aperture; 2) positioning the yoke around a shaft of a door knob; 3) positioning the foot in a non-slipping frictional contact with a floor surface. The method may also include providing the foot with a frictional lower surface adapted for non-slipping frictional engagement with the floor surface. The method may also include providing a hole through a transverse axis of the bolt and inserting a retaining pin through the hole. The method may also include adjusting the length of the security bar by inserting the bolt through a different selected aperture and an alternative cooperating aperture.

These and other features, aspects and advantages of the present invention will become better understood with reference to the following drawings, description and claims.

### BRIEF DESCRIPTION OF THE DRAWINGS

FIG. 1 is a perspective view of the door security bar, shown in use.

FIG. 2 is a perspective view of the door security bar.

FIG. 3 is an exploded view of the door security bar.

FIG. 4 is a section view of the door security bar, taken along line 4-4 in FIG. 1.

FIG. 5 is a section view of the door security bar, taken along line 5-5 in FIG. 4.

FIG. 6 is a section view of the door security bar, illustrating the removal of pin 20 and bolt 18 to adjust upper tube 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a telescopic door security bar for preventing intruders from opening doorway and entering a room.

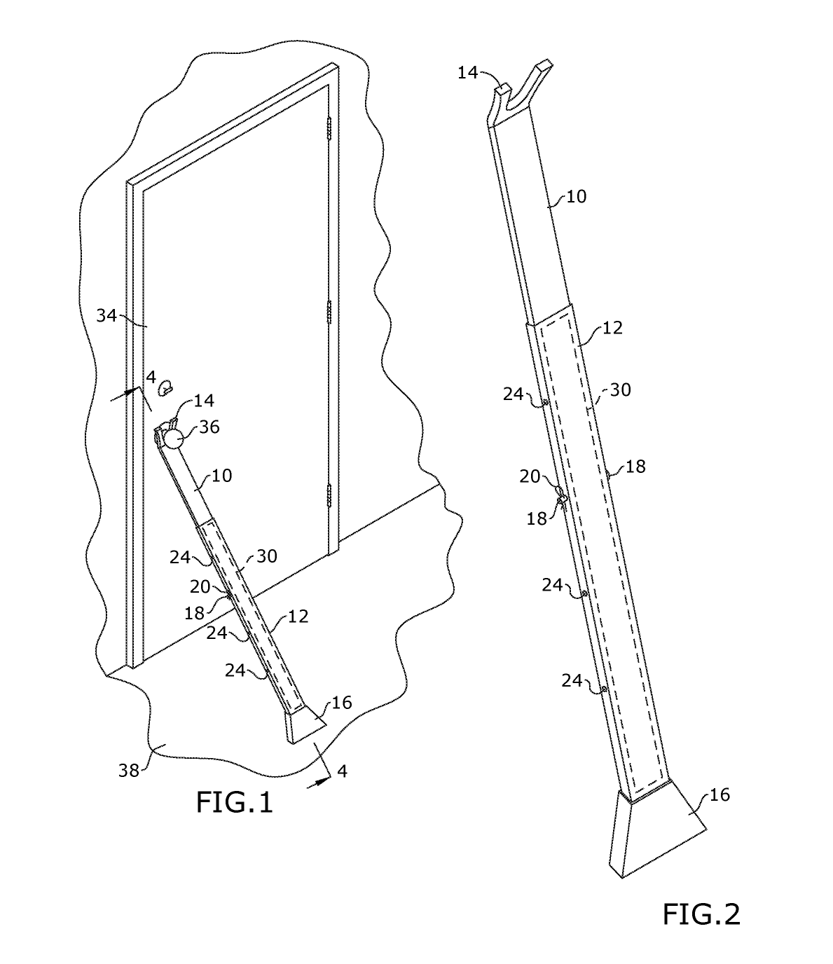

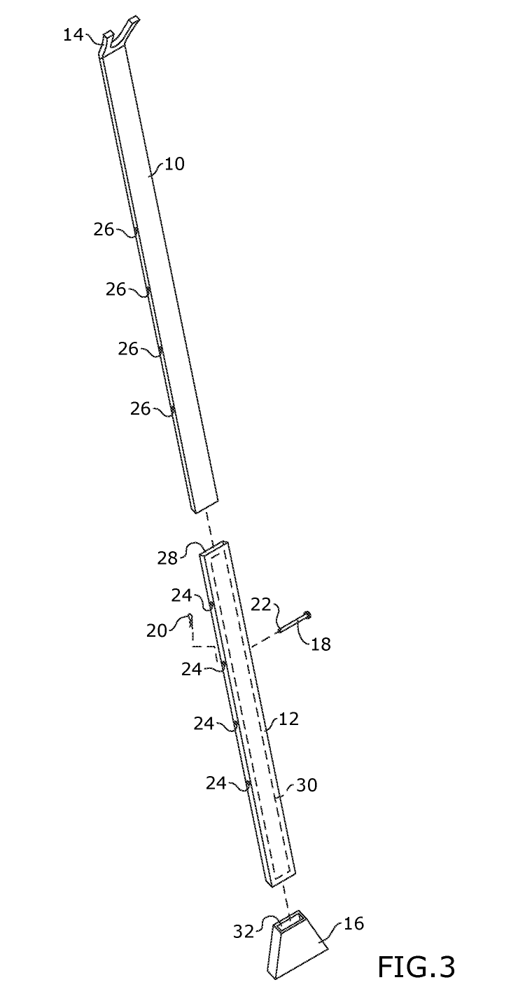

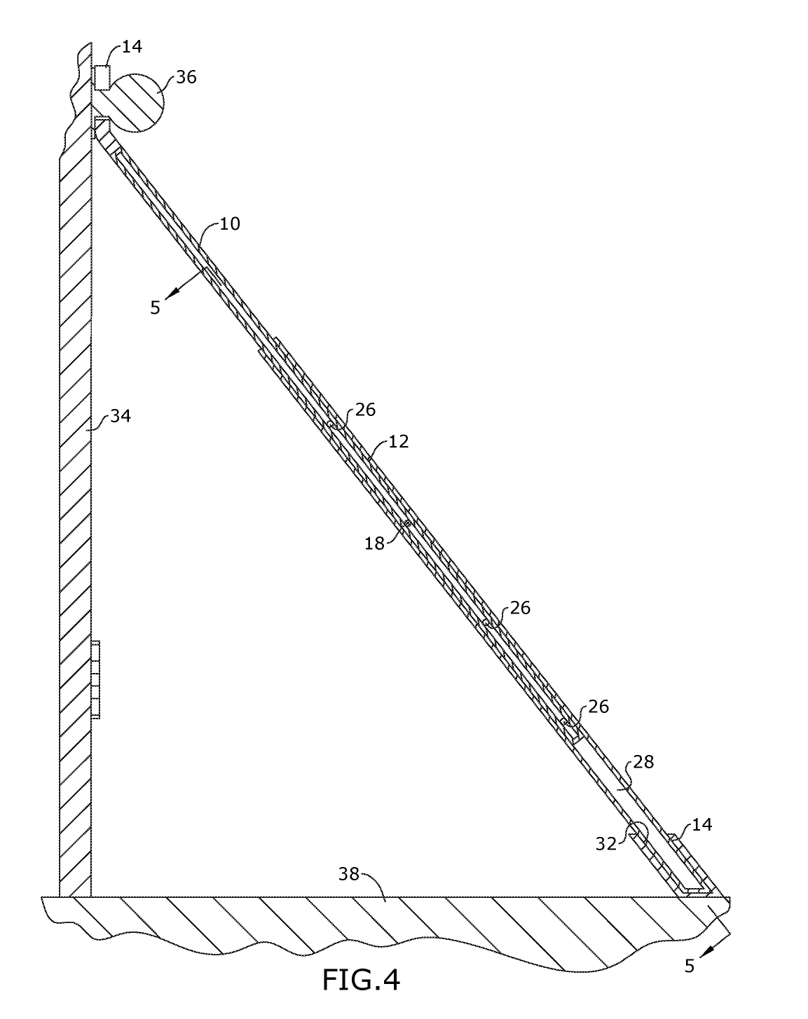

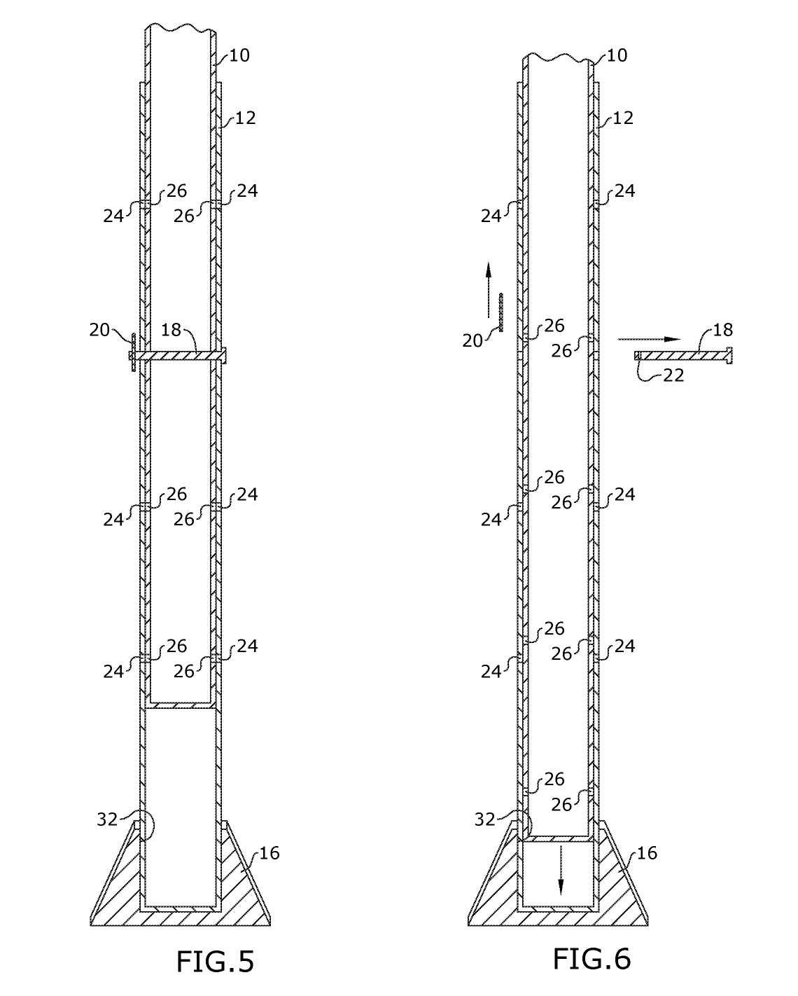

As best seen in reference to FIG. 1, a telescoping door security bar includes an elongate bar having an upper tubular member 10 and a lower tubular member 12 in which one tubular member is received within the other tubular member in a telescopic relation. The upper 10 and lower 12 tubular members may be formed of any shaped tube material, round, box, triangular and the like. Preferably the tubular members 10, 12 are formed of a high strength material such as steel, aluminum, composites, or carbon graphite.

The upper tubular member 10 has a doorknob yoke 14 operatively attached to a top end of the upper tubular member 10. The yoke 14 is adapted to surround the shaft of a doorknob 36 which is attached to a door 34 to control the opening of the door 34 into a structure, such as a room of a dwelling.

The lower tubular member 12 includes a foot 16 operatively attached to a bottom end of the lower tubular member 12. Preferably, the foot 16 is formed to have a frictional lower face so that it may frictionally engage with a floor surface 38, such as tile, hardwoods, carpeting, and the like. In a preferred embodiment the frictional surface may include a rubberized surface. In other embodiments, the frictional surface may include a textured surface. In a preferred embodiment the upper tubular member 10 is received within the lower tubular member 12.

One or more of apertures 24 are defined through the lower tubular member 12 in a spaced apart relation and substantially perpendicular to a longitudinal axis of the lower tubular member 12. The upper tubular member 10 may also have one or more cooperating apertures 26 defined through the upper tubular member 10 and are similarly defined in a spaced apart relation and aligned substantially perpendicular to a longitudinal axis of the upper tubular member 10.

A bolt or pin 18 is received through the apertures 24 of the lower tubular member 12 and the cooperating apertures 26 of the upper tubular member 10. The bolt or pin 18 includes a hole 22 defined through a transverse axis of the bolt 18 that is adapted to receive a retaining pin, such as a cotter pin 20. The length of the door security device may be selectably adjusted by the user selecting the appropriate aperture 24 and cooperating aperture 26 to obtain the desired length of the security device.

The length of the device is adjustable to accommodate the height of the doorknob 36 with respect to the floor surface 38. The length of the device is also adjustable to accommodate for the width of a hall way or passage way within the doorway, that may be defined by an interior wall structure, such as an entryway to a home or dwelling. With the telescopic door security bar of the present invention in place, the opening of the door is prevented in the event a lock or deadbolt is rendered inoperative by an intruder.

It should be understood, of course, that the foregoing relates to exemplary embodiments of the invention and that modifications may be made without departing from the spirit and scope of the invention as set forth in the following claims.

What is claimed is:

1. A telescopic security apparatus, comprising:
a first tubular member having a yoke attached to a top end thereof;
a second tubular member having a foot operatively attached to a bottom end thereof, wherein the first tubular member is telescopically coupled with the first tubular member;
a plurality of apertures defined in a first spaced apart relation through an opposed sidewall of the first tubular member;
a plurality of cooperating apertures defined in a second spaced apart relation through an opposed sidewall the second tubular member in; and
a bolt received through a selected aperture and a selected cooperating aperture.

2. The telescopic security apparatus of claim 1, wherein the foot has a frictional surface defined on a lower surface thereof adapted for non-slipping frictional engagement with a floor surface.

3. The telescopic security apparatus of claim 2, wherein the bolt further comprises a hole extending through a transverse axis thereof.

4. The telescopic security apparatus of claim 3, further comprising:
a retaining pin received in the hole.

5. The telescopic security apparatus of claim 4, wherein the yoke is adapted to substantially surround a shaft of a doorknob.

6. A method of securing a doorway, comprising:
providing a telescopic door security bar comprising:
a first tubular member having a yoke attached to a top end thereof;
a second tubular member having a foot operatively attached to a bottom end thereof, wherein the first tubular member is telescopically coupled with the first tubular member;
a plurality of apertures defined in a first spaced apart relation through an opposed sidewall of the first tubular member;
a plurality of cooperating apertures defined in a second spaced apart relation through an opposed sidewall the second tubular member in; and
a bolt received through a selected aperture and a selected cooperating aperture.
positioning the yoke around a shaft of a door knob.
positioning the foot in frictional contact with a floor surface.

7. The method of claim 6, further comprising:
providing a lower surface of the foot with a frictional surface adapted for non-slip frictional engagement with the floor surface.

8. The method of claim 7, further comprising:
providing a hole extending through a transverse axis of the bolt; and
inserting a retaining pin in the hole.

9. The method of claim 8, further comprising:
adjusting the length of the security bar by inserting the bolt through a different selected aperture and an alternative cooperating aperture.
